(19) United States
(12) Patent Application Publication
(10) Pub. No.: US 2006/0158895 A1
(43) Pub. Date: Jul. 20, 2006

(54) LED flashlight

(76) Inventors: David C. Brands, Portland, OR (US); Richar Yee, Yangjiang (CN); Rainer Opolka, Solingen (DE)

Correspondence Address: KOLISCH HARTWELL, P.C., 200 PACIFIC BUILDING, 520 SW YAMHILL STREET, PORTLAND, OR, 97204, US

(21) Appl. No.: 11/036,598

(22) Filed: Jan. 14, 2005

(51) Int. Cl. F21V 7/04

(52) U.S. Cl. 362/555

(57) ABSTRACT

A flashlight assembly is provided that includes an LED, a battery and switch to selectively provide power to the LED, and an elongated light guide. The light guide is formed of solid, transparent material having a first end positioned immediately adjacent the front portion of the LED. A second end of the light guide is positioned remotely from the LED. The first end of the light guide receives light from the LED and the second end of the light guide emits light that passes through the light guide. A body is also included within which the various components are mounted.

### FIELD OF THE INVENTION

The present invention relates to flashlights using light emitting diodes (LEDS) as the light source.

### BACKGROUND OF THE INVENTION

New high intensity LEDs have increased the light intensity and illumination of flashlights, while decreasing package size. The new high brightness LEDs use a more powerful chip to generate a much brighter light. Manufacturers are producing high brightness light emitting diode packages in a variety of forms. Originally these LEDs were directly substituted for standard incandescent bulbs. LEDs emit light from a plane rather than radiating omnidirectionally from an incandescent filament. The included angle of the light from an LED is much narrower than an incandescent bulb, but it is still not sufficiently narrow to form a beam, and the intensity of the light diminishes quickly with distance.

Flashlights with incandescent bulbs have used parabolic reflectors to shape the light beam, and lenses to focus the beam. The conditioning of the emitted light was less complicated with incandescent bulbs, because the light source could be placed at the focal point of the parabolic reflector to get a focused beam. It is more difficult to get the apparent emitted light to appear at the focal point with a planar light source. LED flashlights have employed a number of methods in order to use reflecting surfaces and focus a beam. One method reflects the LED light from a second mirror at the focal point into the focusing mirror. Another method places the LED at the focal point on a support, but reverses the direction of the LED to emit the light toward the reflector. Yet another method uses a cylindrical reflector that directs the beam. Each of these methods increases the complexity, cost and weight of the flashlight, while absorbing a portion of the light.

In all flashlights, the intensity of the light in the beam is not uniform across the beam. This results in lighter and darker areas in the illuminated field. Some flashlights also have a beam with an irregular shape.

The optimal LED flashlight emits virtually all of the light from the LED into an optimally sized area with a fairly narrow angle. By so doing, light intensity and illumination are not diminished with distance from the viewer. The light should also be relatively uniform across the illuminated area. Small size and light weight are also important for flashlight design.

### SUMMARY OF THE INVENTION

A flashlight assembly is provided that includes an LED, a battery and switch to selectively provide power to the LED, and an elongated light guide. The light guide is formed of solid, transparent material having a first end positioned immediately adjacent the front portion of the LED. A second end of the light guide is positioned remotely from the LED. The first end of the light guide receives light from the LED and the second end of the light guide emits light that passes through the light guide. A body is also included within which the various components are mounted.

### BRIEF DESCRIPTION OF THE DRAWINGS

FIG. 1 is an exploded, side elevation view of a first embodiment of the present invention.

FIG. 2 is a side elevation sectional view of an LED housing of the embodiment of FIG. 1.

FIG. 3 is a side elevation sectional view of a light guide and LED of the embodiment of FIG. 1.

FIG. 4 is a side elevation sectional view of the embodiment of FIG. 1.

FIG. 5 is an end elevation view of an lighting assembly of a second embodiment of the present invention showing three LEDs.

FIG. 6 is a side elevation sectional view of the embodiment of FIG. 5.

FIG. 7 is an end elevation view of a light guide of the embodiment of FIG. 5.

FIG. 8 is a side perspective view of the light guide of the embodiment of FIG. 5.

FIG. 9 is an exploded, side perspective view of the embodiment of FIG. 5.

FIG. 10 is a side elevation sectional view of the embodiment of FIG. 5.

### DETAILED DESCRIPTION OF THE PREFERRED EMBODIMENTS

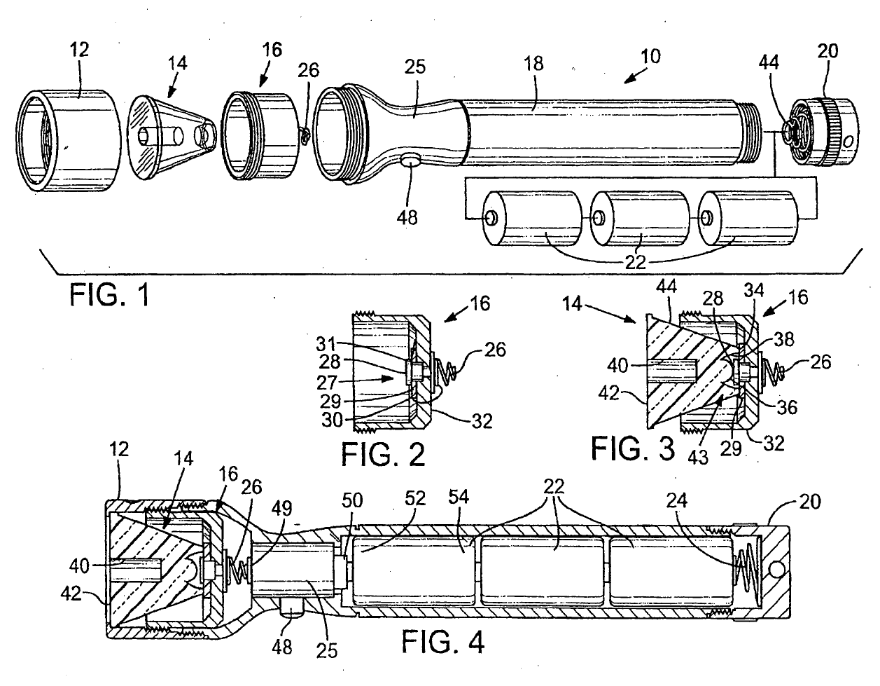

A first embodiment of the present invention is shown best in FIGS. 1 and 4, and is generally identified with the numeral 10. This preferred embodiment, commonly called a flashlight, typically includes a head housing 12, a body 18 and an end cap 20, each of which encloses internal components. Specifically, head housing 12 holds a lighting assembly 16 and a light guide 14. The body holds a switch assembly 25 and a power source 22. End cap 20 holds a spring 24.

As depicted in FIG. 1, lighting assembly 16 and elongated, substantially conical light guide 14 assemble into head housing 12. The phrase “substantially conical” is intended to cover a perfectly conical shape as well as one that is somewhat rounded as shown in FIG. 1. Head housing 12 is typically tubular in configuration, and may include a retaining lip 13 on the front edge to retain the light guide. The head housing is normally internally threaded to receive lighting assembly 16.

As depicted in FIG. 2, a tubular LED housing 32 having a closed end is also provided. Lighting assembly 16 includes the LED, generally indicated at 27, which includes an LED emitter 28 and an LED base 29. LED emitter 28, and the LED base 29, are assembled to the closed end of LED housing 32. LED base 29 has a first terminal 30 and a second terminal 31. The first terminal is electrically isolated from LED housing 32 and is connected to spring 26. Second LED terminal 31 is connected to LED housing 32.

As depicted in FIG. 3, light guide 14 may be manufactured from a single piece of material formed in the desired shape. The light guide 14 may be formed of a transparent, rigid material, with a high index of refraction such as glass, plexiglass or other polymer. As depicted in the same figure, light guide 14 generally includes an admitter face 43, an emitter face 42, a hole 40, and a side wall 44. Admitter face 43 typically includes three faces. The first face, which shall be referred to as an annular base 34, is in the general configuration of an annular ring. In the depicted embodiment, annular base 34 contacts LED base 29 when annular base 34 is assembled to LED housing 32. In alternate embodiments (not shown) annular base 34 may simply contact LED housing 32, The second face shall be referred to as a protrusion 36 facing LED emitter 28. The third face shall be referred to as an interior face 38. Protrusion 36 and interior face 38 may be curved as shown to form hemispheres, but may have other shapes to form light admitting faces of different configurations. Side wall 44 may form a generally conical shape as shown in the preferred embodiment of FIG. 3. The sidewalls may also form parallel sides to form a generally cylindrical surface, as will be discussed and depicted below. Alternatively, it may be curved to form a generally parabolic surface (not shown).

Light guide 14, when assembled, is operatively coupled to LED 27. Light guide 14 is designed to admit substantially all of the light from LED emitter 28, and emit the light as a substantially collimated beam from emitter face 42 with relatively uniform brightness.

A well known property of light guide 14 is that the light exiting the light guide at emitter face 42, where the light guide is sufficient in length, will be relatively uniform in brightness. This relatively uniform brightness is due to the mixing within light guide 14 due to multiple reflections within the light guide.

As depicted in FIG. 3, emitter face 42 normally has a hole 40 that is aligned along the longitudinal axis of light guide 14. Hole 40 typically starts from emitter face 42 and extends into body 18 of light guide 14.

FIG. 4 illustrates the assembled flashlight 10 of FIG. 1. Emitter face 42 of light guide 14 is inserted into head housing 12, and is seated against front lip 13 of head housing 12. Lighting assembly 16 screws into head housing 12. When lighting assembly 16 is screwed in, LED 27 is seated into admitter face 43 of light guide 14. Light guide 14 is held between lip 13 and LED base 29. In an alternate configuration (not shown), annular base 34 has an inside diameter larger than the LED base 29. In this configuration annular base 34 abuts LED housing 32, and LED 27 is seated into admitter face 43.

Head housing 12 typically screws onto body 18. In the preferred embodiment shown in FIG. 4, body 18 typically contains switch assembly 25 and power source 22. Switch assembly 25 has a first switch contact 49, and a second switch contact 50. First switch contact 49 presses against LED housing spring 26 on lighting assembly 16 when assembled. End cap 20 includes an end cap spring 24. End cap 20 screws onto body 18, and end cap spring 24 contacts power source 22. The end cap spring compresses as the end cap is assembled to the body. The compression exerts an axial force, pressing first power source electrode 52 onto second switch contact 50.

In one configuration, as an example only, light guide 14 is manufactured for use in an LED flashlight 10. Emitter face 42 of light guide 14 is normally about 25 mm in diameter. Admitter face 43 is typically 9 mm in diameter at the outside of annular base 34, and 5.6 mm at the inside of the annular base. Protrusion 36 may be a hemisphere, with a base that is about 4 mm in diameter. The distance from emitter face 42 to admitter face 34 is typically 19.3 mm. The diameter of LED emitter face 28 is normally 5.5 mm. In the depicted embodiment the LED emitter face is 2.5 mm above LED base 29, with the top of the hemisphere being 2.6 mm below annular base 34. When assembled, this will typically provide a 0.1 mm clearance between the hemispheric protrusion 36 and LED emitter 28. Hole 40 may be 11.2 mm deep and 5 mm in diameter. Light guide wall 44 forms a generally parabolic curve.

LED housing 32, body 18, head 12 and end cap 20 are normally electrically conductive, forming an electrical path between second LED terminal 31, and second power source electrode 54. Alternatively, body 18 may be non conductive, and a separate conductor (not shown) may connect end cap spring 24 to end cap second LED terminal 31. The path to first LED terminal 30 passes from first power source electrode 52 through switch assembly 25, through LED housing spring 26, to first LED terminal 30. Power to the first LED terminal 30 can be interrupted by the functioning of switch assembly 25, as controlled by switch button 48. The switch button could alternatively take the form of a switch, or lever.

Switch assembly 25 may be located in other positions, such as in end cap 20. In this configuration the switch assembly would interrupt the current flow between spring 24 and end cap 20. In this configuration, first power source electrode 52 would press against spring 26, making electrical contact with first LED terminal 30 (again, not shown).

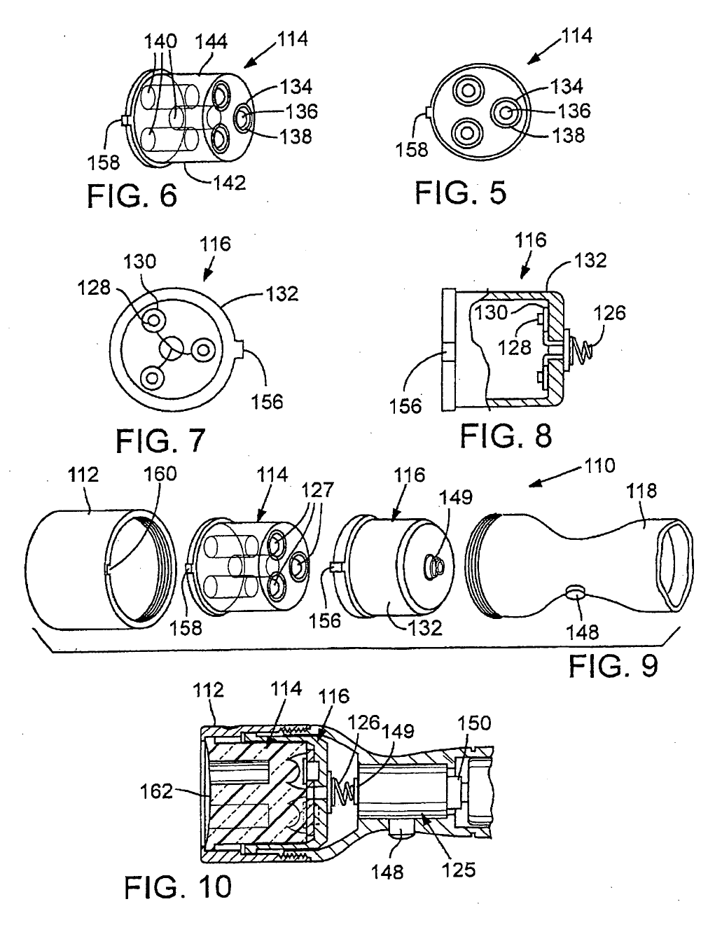

### Embodiment of FIGS. 5-10

FIGS. 5 through 110 illustrate a second embodiment of elongated light guide 114 and lighting assembly 116. Because many of the components of this second embodiment 110 are similar to embodiment 10, corresponding numerals will be used to designate corresponding parts. For example, light guide 14 will be designated with the numeral 114 and light assembly 16 will be designated with the numeral 116. In this embodiment light guide 114 is generally cylindrical in configuration. It also includes a rounded end 162, which may be convex or concave but in the depicted embodiment is concave. Lighting assembly 116 has three LEDs. First LED terminal 130 is attached to housing spring 126, and is electrically isolated from LED housing 132. Light guide 114 has three admitter faces 143, corresponding to the positions of the LEDs in lighting assembly 116. Light guide 114 and LEDs 127 in lighting assembly 116 are normally oriented in relation to rotation along the longitudinal axis of light guide 116. There are many approaches for maintaining this orientation. One example of orienting the components is shown in FIGS. 5 through 10. In this example head housing 112, light guide 114, and LED housing 132 are keyed to maintain a rotational orientation between the three components along a light guide axis. FIGS. 5 and 6 show an LED housing orienting tab 158. FIGS. 7 and 8 show a light guide orienting tab 158. Light guide orienting tabs 156 and LED housing orienting tab 158 slide into head orienting slot 160. The three annular bases 134 on the light guide abut the three LED bases 129. All the light emitted by the three LEDs is admitted to the light guide. In an alternative configuration (not shown) annular base 134 has an inside diameter larger than the LED base 129. In this configuration annular base 134 abuts LED housing 132, and LED 127 is seated into admittor face 143.

FIG. 9 shows three LEDs 127 with orienting tabs 156 and 158, and slot 160. Head housing 112 is screwed onto body 118. LED housing spring 126 is compressed as body 118 is assembled to the head housing 112. LED housing spring 126 holds lighting assembly 116 firmly against light guide 114 as it is compressed.

Power source 22 can be any of a number of devices that will supply the voltage required by the LED, and any supporting electronic components. It can be lead-acid batteries, lithium batteries, a kinetic energy storage device, or another source. Alternatively, the power source may even be in the form of a plug-in power source.

Although the invention has been described in detail for the purpose of illustration, it is to be understood that such detail is solely for that purpose, and variations can be made therein by those skilled in the art without departing from the spirit and scope of the invention, except as it may be limited by the claims.

Applicants regard the subject matter of their invention to include all novel and non-obvious combinations and subcombinations of the various elements, features, functions and/or properties disclosed herein. No single feature, function, element or property of the disclosed examples is essential to all examples. The following claims define certain combinations and subcombinations which are regarded as novel and non-obvious. Other combinations and subcombinations of features, functions, elements and/or properties may be claimed through amendment of the present claims or presentation of new claims in this or a related application. Such claims, whether they are different, broader, narrower or equal in scope to the original claims, are also regarded as included within the subject matter of applicants' invention.

1. A flashlight assembly comprising:
an LED having a luminescent front portion;
means for selectively providing power to the LED;
an elongated light guide formed of solid, transparent material having a first end positioned immediately adjacent the front portion of the LED, and having a second end positioned remotely therefrom, the first end of the light guide receiving light from the LED and the second end of the light guide emitting light; and
a body to which the LED, the means and the light guide are mounted.

2. The flashlight assembly of claim 1 wherein the light guide is substantially conical in configuration.

3. The flashlight assembly of claim 2 wherein the light guide is somewhat rounded.

4. The flashlight assembly of claim 1 wherein the light guide is substantially cylindrical in configuration.

5. The flashlight assembly of claim 4 wherein the second end of the light guide is rounded.

6. The flashlight assembly of claim 5 wherein the second end of the light guide is concave.

7. The flashlight assembly of claim 1 wherein the light guide is formed of glass.

8. The flashlight assembly of claim 1 wherein the light guide is formed of plastic.

9. A flashlight assembly comprising:
an LED having a front luminescent portion;
a battery and switch to selectively provide power to the LED;
a light guide formed of solid, transparent material having a first end positioned adjacent the front portion of the LED, and having a second end positioned remotely therefrom, the first end of the light guide receiving light from the LED and the second end of the light guide emitting light, wherein the length extending between the first and second ends is at least half the width of the light guide at its widest point; and
a body to which the LED, the battery, the switch and the light guide are mounted.

10. The flashlight assembly of claim 9 wherein the light guide is substantially conical in configuration.

11. The flashlight assembly of claim 9 wherein the light guide is substantially cylindrical in configuration.
